(19) United States
(12) Patent Application Publication
(10) Pub. No.: US 2005/0091068 A1
(43) Pub. Date: Apr. 28, 2005

(54) Smart translation of generic configurations

(76) Inventors: Sundaresan Ramamoorthy, San Jose, CA (US); Jennifer Fu, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,605

(22) Filed: Oct. 23, 2003

(51) Int. Cl. G06F 17/60

(52) U.S. Cl. 705/1

(57) ABSTRACT

System and method for implementing a policy in a network, the network having a device-agnostic policy implementation; a plurality of network devices, at least two of the devices being dissimilar; and a plurality of device translators, each device translator corresponding to a respective one of the plurality of network devices, at least two of the device translators being dissimilar, each of the plurality of device translators translating the device-agnostic policy implementation into corresponding device-specific implementations.

### TECHNICAL FIELD OF THE INVENTION

The present invention relates to computer networks, and more particularly to improvements in management of vendor-specific policies in networks.

### BACKGROUND

In a computer network, each device or application has a vendor-specific configuration. Functional areas, such as a firewall, application access rule, etc., are managed by tools written and designed by each vendor. Typically, each functional area is managed by tools that are unique to the particular vendor or device. Some devices are controlled by a vendor-specific CLI (Command Line Interface) and others are controlled by a vendor-specific API (Application Programming Interface).

Firewalls attempt to protect networks from unauthorized access and hostile exploitation or damage to computers connected to the network. Firewalls provide a server through which all access to the network must pass. Firewalls are centralized systems that require administrative overhead to maintain.

An access control list (ACL), generally, is a data structure that defines who has access to a single specified object stored on a computer or network. More specifically, an ACL typically indicates the access rights each user or group has. Access rights for file objects typically include the right to read a file, write the file, delete the file, and execute the file. Examples of objects to which ACLs may refer include files, directories, subdirectories, web services, computer resources, and the like. In known ACL-based systems, each object includes a security attribute that identifies its corresponding ACL. Typically the metadata for each object points to its corresponding ACL.

Many policies may be managed in a network. Access control, quality of service, backup, and availability are possible policies that may be monitored in a network, each managed by tools that are unique to the particular vendor or device.

In a large network, or in a network with several devices and applications from different vendors, it is difficult to manage the different devices and applications. The network can be managed by writing extensive code, usually in C or Java, to translate each vendor-specific configuration into one vendor-agnostic configuration. Then, when a new device or application is added to the network, additional code must be written to add the new configuration of the device or application to the existing code, creating one vendor-agnostic or non-vendor-specific configuration. Each revision of code is lengthy, requiring the time to code and test, before the new device or application may be properly managed in the network.

Accordingly, a need exists for a technique with which vendor-specific tools can be automatically translated into a single vendor-agnostic configuration.

### SUMMARY

The present invention is directed to a system and method for implementing a policy in a network, the network having a device-agnostic policy implementation; a plurality of network devices, at least two of the devices being dissimilar; and a plurality of device translators, each device translator corresponding to a respective one of the plurality of network devices, at least two of the device translators being dissimilar, each of the plurality of device translators translating the device-agnostic policy implementation into corresponding device-specific implementations.

### DESCRIPTION OF THE DRAWINGS

The features, aspects, and advantages of the present invention will become better understood with regard to the following description, appended claims, and accompanying drawings where:

FIG. 1 depicts a system configuration of an embodiment of the present invention; and

FIG. 2 depicts a flowchart showing the operation of an embodiment of the present invention.

### DETAILED DESCRIPTION

The present invention is a system and methodology of using a vendor independent representation of a device or application in a particular functional area, such as a firewall, an application access rule, etc., and writing a smart translator to transform the vendor independent configuration into a vendor-specific CLI (Command Line Interface) or to generate a vendor-published API (Application Programming Interface).

In general, a document may be encoded in SGML (Standard Generalized Markup Language) or an SGML derivative. Examples of SGML derivatives are HTML (HyperText Markup Language) and XML (Extensible Markup Language). HTML is a subset of SGML that is directed toward document interchange, and is primarily a publishing language. XML is a simplified version of SGML, tailored to structured document content.

When a user wishes to print or display an XML document, the software (i.e. the parser, compiler or other application) processes the contents of the XML document. The software may be an XSL (Extensible Stylesheet Language) stylesheet, which can be designed to create a viewable version of the XML document, or can be designed to use or manipulate the XML document.

HTML and XML are tag languages, where specially-designated constructs referred to as “tags” are used to delimit (or “mark up”) information. In the general case, a tag is a keyword that identifies what the data is which is associated with the tag, and is typically composed of a character string enclosed in special characters. “Special characters” means characters other than letters and numbers, which are defined and reserved for use with tags. Special characters are used so that a parser processing the data stream will recognize that this a tag. A tag is normally inserted preceding its associated data: a corresponding tag may also be inserted following the data, to clearly identify where that data ends. As an example of using tags, the syntax “<p>” in HTML indicates the beginning of a paragraph. In XML, “<email>” could be used as a tag to indicate that the character string appearing in the data stream after this tag is to be treated as an e-mail address; the syntax “</email>” would then be inserted after the character string, to delimit where the e-mail character string ends.

XML is an “extensible” markup language in that it provides users the capability to define their own tags. This makes XML a very powerful language that enables users to easily define a data model, which may change from one document to another. When an application generates the tags (and corresponding data) for a document according to a particular XML data model and transmits that document to another application that also understands this data model, the XML notation functions as a conduit, enabling a smooth transfer of information from one application to the other. By parsing the tags of the data model from the received document, the receiving application can re-create the information for display, printing, or other processing, as the generating application intended it. Conversely, HTML uses a particular set of predefined tags, and is therefore not a user-extensible language.

XML is a well-formed notation, meaning that all opening tags have corresponding closing tags (with the exception of a special “empty” tag, which is both opened and closed by a single tag, such as “<email/>”), and each tag that nests within another tag is closed before the outer tag is closed. HTML, on the other hand, is not a well-formed notation. Some HTML tags do not require closing tags, and nested tags are not required to follow the strict requirements as described for XML (that is, in HTML a tag may be opened within a first outer tag, and closed within a different outer tag).

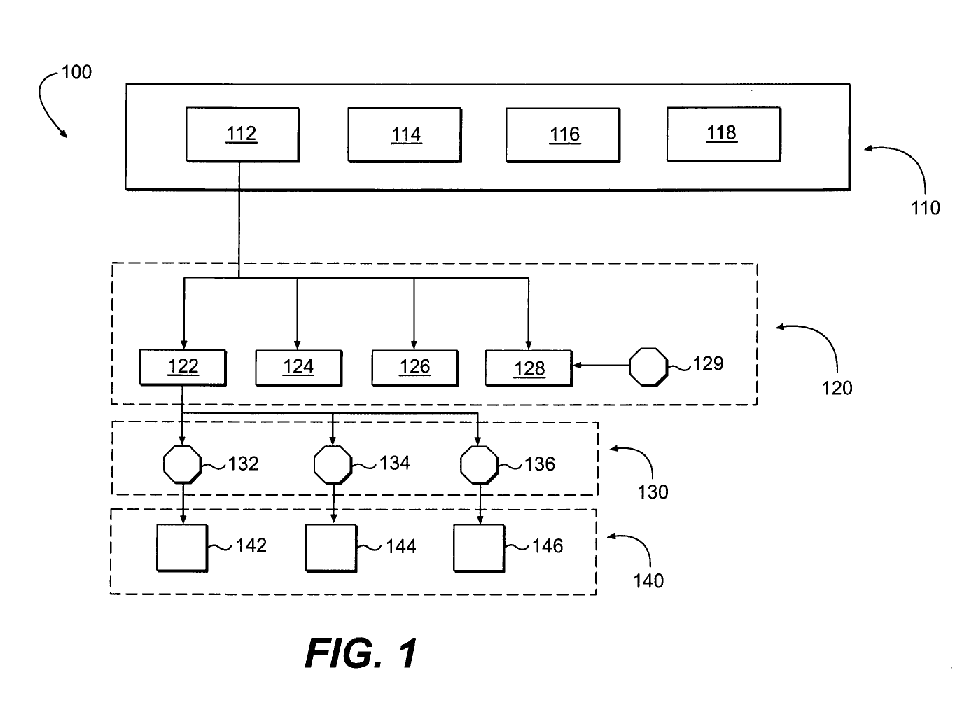

With respect now to FIG. 1 of the Drawings, there is represented an system diagram showing a network, generally designated by the reference numeral 100, as utilized in an embodiment of the present invention. As shown in FIG. 1, there are abstract policy definitions 110, vendor independent policy implementations 120, translators 130, and specific devices 140. The diagram generally depicts the interaction of the various components, as will be explained in more detail hereinbelow.

As shown in FIG. 1, the policy definitions 110 may be several policy definitions, here chosen to be access control 112, quality-of-service 114, backup 116, and availability 118. It should be understood that the policy definitions 110 may include other definitions than these. For the purposes of illustration, only access control 112 is used to describe the present invention, although it should be understood that the present invention may be applied to all of the policy definitions 110, as well as other policy definitions. The vendor independent policy implementations 120 may be a firewall 122, a VPN (Virtual Private Network) 124, J2EE (Java 2, Enterprise Edition) Application 126, and an operating system 128, governed by a custom policy 129. The custom policy 129 is imported through a translator to properly configure the operating system 128. For the purposes of illustration, only the firewall 122 is used to describe the present invention, although it should be understood that the present invention may be applied to all of the access control policies 120. The vendor independent firewall 122 may be implemented through Cisco PIX ACL 142, through Checkpoint API 144, or through Nortel ACL 146. Each specific device 140 has a corresponding translator 130 that produces a device-specific API or ACL, i.e., translator 132 produces ACL 142 for the Cisco PIX, translator 134 produces an API for Checkpoint, and translator 136 produces ACL 146 for Nortel.

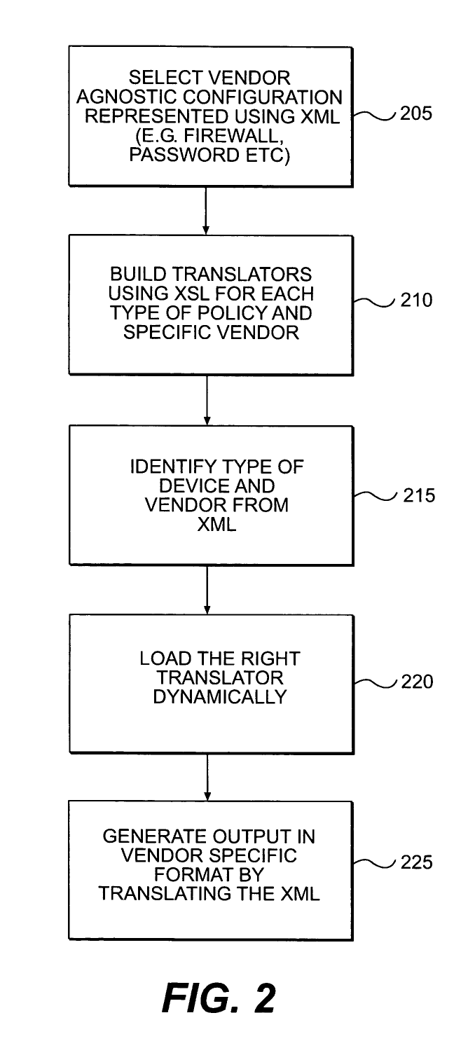

With reference now to FIG. 2, there is shown a flowchart depicting the flow of an embodiment of the present invention. Initially, a non-vendor-specific configuration is represented using XML (step 205). Next, a translator is built using XSL for each type of policy and specific vendor or device (step 210). Then, the type of device and vendor is identified from XML (step 215). The specific translator is dynamically loaded (step 220). Output is generated in vendor-specific format by translating the XML (step 225).

In this embodiment, it should be understood that once the translators for each type of policy and specific vendor or device is written in XSL, then the addition or maintenance of any policy or specific device is governed a by simple, non-vendor-specific XML file. Various illustrations of embodiments of the present invention are shown hereinbelow.

A high-level illustration of an XML file in policy management that extracts information for each policy type is shown below.

<policy type=”middleware”>
<app name=”database” cost=”300”>
<time response=”8” availability=”99”>
</app>
</policy>

A corresponding XSL file that extracts information for each type is shown.

```
<xsl:template match=”app”>
    “<xsl:value-of select=”@name”/>”,
    <xsl:value-of select=”@cost”/>,
    <xsl:apply-templates select=”time”/>
</xsl:template>
```

The XML file is translated, using the XSL file, to produce a corresponding Java API, as shown.

Application.newInstance
(“database”, 300, 8, 99)

The above XML, XSL, and Java code show a simple illustration of using XML to define a policy and then translate it into Java, using XSL rather than writing the particular Java code. In this way, non-vendor-specific XML files can be made for various devices, without tailoring the XML code to a particular vendor. The XML file is then translated, using a particular XSL translator, into vendor-specific code, here a Java API.

A high-level illustration of an XML file in policy management, specifically for use with a firewall for a Cisco PIX, is shown.

```
<policy type=”security”>
    <fw id=”655” name=”perimeter” type=”fw”>
        <allow>
            <service id=”service104” name=”telnet” protocol=”3”
            port=”23” seq=”1”>
                <from ip=”15.4.28.100” mask=”255.255.248.0”/>
              <to ip=”104.3.30.20” mask=”255.255.248.0”/>
            </service>
        </allow>
    </fw>
</policy>
```

A corresponding XSL file that extracts information, specifically for use with a firewall for a Cisco PIX, is shown.

```
<xsl:template match=”fw”>
    <xsl:for-each select=”*/allow”>
        access-list act_group permit
        <xsl:apply-templates select=”service”/>
    </xsl:for-each>
</xsl:template>
```

The above XML file is translated into corresponding Cisco PIX CLI using the XSL file. The resulting file is shown.

access-list act_group permit
telnet 23 15.4.28.100 104.3.30.20

The above XML, XSL, and CLI code is a simple illustration of using XML to define a policy and then translate it into CLI, using XSL rather than writing the particular CLI code. As above, non-vendor-specific XML files can be made for various devices, without tailoring the XML code to a particular vendor. The XML file is then translated, using a particular XSL translator, into vendor-specific code, here a Cisco PIX CLI.

Another high-level illustration of an XML file in policy management, specifically for use with a firewall for Load-balancer, is shown.

```
<policy type=”security”>
    <fw id=”655” name=”perimeter” type=”fw”>
        <allow>
            <service id=”service104” name=”telnet” protocol=”3”
            port=”23” seq=”1”>
                <from ip=”15.4.28.100” mask=”255.255.248.0”/>
              <to ip=”104.3.30.20” mask=”255.255.248.0”/>
            </service>
        </allow>
    </fw>
</policy>
```

A corresponding XSL file that extracts information, specifically for use with a firewall for Load-balancer, is shown.

```
<xsl:template match=”fw”>
    <xsl:for-each select=”*/allow”>
        access-list act_group permit
        <xsl:apply-templates select=”service”/>
    </xsl:for-each>
</xsl:template>
```

The above XML file, when translated using the XSL file, produces corresponding Foundry ServerIron CLI, as shown.

access-list 102 permit telnet
15.4.28.100 104.3.30.20 23 log

The above XML, XSL, and CLI code is a simple illustration of using XML to define a policy and then translate it into CLI, using XSL rather than writing the particular CLI code. As shown, non-vendor-specific XML files can be made for various devices, without tailoring the XML code to a particular vendor. The XML file is then translated, using a particular XSL translator, into vendor-specific code, here Foundry ServerIron CLI.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

1. A system for implementing a policy in a network, said system comprising:
a device-agnostic policy implementation;
a plurality of network devices, at least two of said devices being dissimilar; and
a plurality of device translators, each device translator corresponding to a respective one of said plurality of network devices, at least two of said device translators being dissimilar, each of said plurality of device translators translating said device-agnostic policy implementation into corresponding device-specific implementations.

2. The system according to claim 1, wherein said device-agnostic policy implementation is selected from the group consisting of firewall, Virtual Private Network, Java 2 Enterprise Edition Application, and custom operating system.

3. The system according to claim 1, wherein said device-agnostic policy implementation implements a policy selected from the group consisting of access control, quality of service, backup, and availability.

4. The system according to claim 1, wherein said device translators are represented by Extensible Stylesheet Language (XSL) code.

5. The system according to claim 1, wherein said device-agnostic policy implementation is Extensible Markup Language (XML) code.

6. The system according to claim 3, wherein said policy is represented by Extensible Markup Language (XML) code.

7. The system according to claim 1, wherein the device-specific implementation is represented by Command Line Interface (CLI) code.

8. The system according to claim 1, wherein the device-specific implementation is represented by Application Programming Interface (API) code.

9. The system according to claim 1, wherein the device-specific implementation is represented by Java code.

10. A method comprising:
representing a vendor-agnostic configuration;
building a translator for a specific policy and vendor;
identifying a device;
loading said translator; and
translating said vendor-agnostic configuration into vendor-specific configuration using said translator.

11. The method according to claim 10, wherein said vendor-agnostic configuration is represented by Extensible Markup Language (XML) code.

12. The method according to claim 10, wherein said translator is represented by Extensible Stylesheet Language (XSL) code.

13. The system according to claim 10, wherein said specific policy is selected from the group consisting of firewall, Virtual Private Network, Java 2 Enterprise Edition Application, and custom operating system.

14. The system according to claim 10, wherein said specific policy is selected from the group consisting of access control, quality of service, backup, and availability.

15. The system according to claim 10, wherein the vendor-specific configuration is represented by Command Line Interface (CLI) code.

16. The system according to claim 10, wherein the vendor-specific configuration is represented by Application Programming Interface (API) code.

17. The system according to claim 10, wherein the vendor-specific configuration is represented by Java code.

18. A computer readable medium containing instructions for implementing a policy in a computer network, said instructions comprising:
representing a vendor-agnostic configuration;
building a translator for a specific policy and vendor;
identifying a device;
loading said translator; and
translating said vendor-agnostic configuration into vendor-specific configuration using said translator.
